(19) United States
(12) Patent Application Publication
(10) Pub. No.: US 2026/0176193 A1
(43) Pub. Date: Jun. 25, 2026

(54) BREAK-RESISTANT ELECTROCHEMICAL SENSOR CONTAINING BREAK-RESISTANT MEMBRANE GLASS, METHOD FOR MANUFACTURING A BREAK-RESISTANT MEMBRANE GLASS FOR A GLASS COMPONENT OF A MEASURING HALF-CELL, AND METHOD FOR MANUFACTURING THE BREAK-RESISTANT GLASS ASSEMBLY OF AN ION-SENSITIVE SINGLE-ROD MEASURING CHAIN

(71) Applicant: Endress+Hauser Conducta GmbH+Co. KG, Gerlingen (DE)

(72) Inventor: Matthäus Speck-Dechant, Göpfersdorf (DE)

(21) Appl. No.: 19/426,678

(22) Filed: Dec. 19, 2025

(30) Foreign Application Priority Data
Dec. 19, 2024 (DE) 10 2024 138 917.6

(51) Int. Cl. C03C 21/00; C03B 32/00; G01N 27/36

(52) U.S. Cl. CPC C03C 21/002; C03B 32/00; G01N 27/36

(57) ABSTRACT

A method for manufacturing a break-resistant membrane glass of a glass component of a measuring half-cell of an analyte-sensitive sensor includes providing at least one membrane glass of a sensor which is blown onto a shaft and which consists of a sodium-and lithium-containing glass, such as sodium and lithium silicate glass, or of a lithium-containing glass, such as lithium silicate glass, or which comprises one of these materials. The method further includes bringing the at least one membrane glass blown onto a shaft into contact with a pickling solution containing sodium ions, such as a sodium acetate or sodium nitrate solution or a melt containing sodium ions, and heating the membrane glass at a temperature of 200° C.-500° C. for 10-20 minutes, wherein the membrane glass is ion-sensitive.

### CROSS-REFERENCE TO RELATED APPLICATION

The present application is related to and claims the priority benefit of German Patent Application No. 10 2024 138 917.6, filed on Dec. 19, 2024, the entire contents of which are incorporated herein by reference.

### TECHNICAL FIELD

The determination of the concentration of an analyte in a measuring medium plays an important role in many industrial applications, for example in chemical or pharmaceutical engineering, in food technology, in biotechnology, but also in non-industrial analytical applications, for example in environmental measurement technology. For determining ion concentrations, sensors that have a sensor element with an analyte-sensitive component are often used in laboratories and in industrial process plants. An analyte-sensitive membrane, for example, can be used as an analyte-sensitive component. For example, the glass membrane of the known pH glass electrode is sensitive to the concentration or activity of H⁺ or H₃O⁺ ions in a measuring medium.

### BACKGROUND

In DE 20 2006 017 215 U1, for example, measuring probes with glass electrodes for pH and redox measurements are described.

Prior-art pH glass sensors consist fundamentally of two half-cells (pH and reference half-cell). At least the pH half-cell comprises a pH-sensitive glass membrane, connected to an electrically insulating shaft glass tube, which usually ends coaxially with the outer shaft tube in the plug head. Despite the high theoretical strength of the glass material itself, pH glass sensors are relatively fragile in practice. Particularly in the area of the pH glass membrane in contact with the medium and in the subsequent transition area to the shaft glass tube, residual stresses remain as a result of the manufacturing process. Residual stresses parallel to the glass surface in the glass are generally unwanted and lead to glass breakage (membrane crack) in the case of high amplitudes or micro-defects or inadequate joining of the glasses (e.g., in the membrane-glass-shaft transition).

A thermally partially tempered pH glass membrane often exhibits better performance (lower impedance) and higher breaking strength. However, such pH glass membranes tend to experience significantly greater splintering when the break limit is exceeded.

This serious disadvantage largely excludes the inline use of pH glass sensors in some core industries (such as the food/beverage industry) today.

However, shatter-proof electrochemical glass sensors with a shatter-proof glass component, preferably a glass shaft component, are desired in many applications. For example, the glass has excellent corrosion resistance to acids and alkalis.

The problem addressed by the present invention is therefore that of providing a sensor containing a glass component containing a membrane glass, wherein the membrane glass consists of a break-resistant glass which has better properties with regard to break resistance than the conventionally used lithium-containing membrane glass.

### SUMMARY

The object is achieved by a method for manufacturing a break-resistant glass component of an analyte-sensitive sensor, comprising: providing at least one membrane glass of a sensor, which is blown onto a shaft and which consists of a sodium-and lithium-containing glass, preferably of sodium and lithium silicate glass, or of a lithium-containing glass, preferably of lithium silicate glass, or which comprises one of these materials; bringing the at least one membrane glass blown onto a shaft into contact with a pickling solution containing sodium ions, preferably a sodium acetate or sodium nitrate solution or a melt containing sodium ions; and heating the membrane glass at a temperature of 200° C.-500° C., preferably 300-450° C., more preferably 400-450° C. for 10-20 minutes, wherein the membrane glass is ion-sensitive.

In the method described above, both a reduction of the stresses parallel to the surface in the glass of the pH glass/shaft transition and a chemical strengthening/hardening of the pH glass membrane take place. The glass membrane can be made 4-5 times more break-resistant. The intended residence time in the heat treatment step is sufficient, as due to the good mobility of the Li⁺ ions of the lithium silicate pH membrane glass, both the Li/Na ion exchange between the pickling solution and the membrane glass and between the membrane glass and the shaft glass takes place sufficiently quickly. The heat treatment step is short enough to avoid devitrification of the pH glass.

In one embodiment of the method, the pickling solution containing sodium ions, preferably a sodium acetate or sodium nitrate solution or a melt containing sodium ions, further contains potassium ions. In an alternative embodiment of the method, after the heating step, the membrane glass is brought into contact with a pickling solution containing potassium ions, preferably a potassium acetate or potassium nitrate solution or a melt containing potassium ions.

This step is also carried out at a temperature of 200° C.-500° C., preferably 300-450° C., more preferably 400-450° C. for 10-20 minutes.

In one embodiment of the above-mentioned method, the bringing into contact with a pickling solution comprises immersing in the pickling solution or spraying with the pickling solution.

In one embodiment, after immersion in the pickling solution or spraying with the pickling solution, the glass is heated with a laser.

In one embodiment, at least the membrane glass is immersed in the melt.

In one embodiment of the method, the ion-sensitive sensor is an analyte-sensitive sensor, preferably a cation-sensitive or an anion-sensitive sensor.

In one embodiment of the method, the cation-sensitive sensor is an Na⁺, K⁺ sensor or a pH-sensitive or hydronium-ion-sensitive sensor.

In one embodiment of the method, the shaft consists of a sodium silicate glass hardened with potassium ions or the shaft contains a sodium silicate glass hardened with potassium ions.

The term shaft refers to the shaft of the glass component of the measuring half-cell.

In one embodiment, the method comprises the method steps according to the invention or an embodiment thereof, followed by the steps of:
cooling of the glass component containing a shaft and break-resistant membrane glass blown onto the shaft and integrally bonded to the glass component to room temperature
cleaning of the glass component, wherein the cleaning is preferably automated and preferably carried out with deionized water.

The invention also relates to a method for manufacturing the break-resistant glass assembly of a single-rod measuring chain comprising a hardened ion-sensitive membrane glass, comprising: providing a glass body containing an inner shaft tube having a cylindrical cavity and an outer shaft tube surrounding the inner shaft tube and integrally bonded to the inner shaft tube and closed at the bottom; inserting a cylindrical diaphragm into a receptacle of the inner shaft tube, the diaphragm containing an O-ring on the outer surface for sealing with the inner shaft tube; and break-resistant membrane glass of a glass component of a measuring half-cell according to the invention or an embodiment thereof, followed by the steps; and inserting the glass component of a measuring cell, containing a shaft tube and a pH-sensitive glass membrane integrally bonded to the shaft tube, into the cylindrical cavity.

The inner shaft tube and the outer shaft tube are arranged coaxially. The integral bond is provided by fusion. The integral bond and the ion-sensitive membrane glass are arranged on the side of the single-rod measuring chain facing the medium during operation.

In a preferred embodiment, the glass body consists of a sodium-containing glass hardened with K⁺ ions, preferably of a sodium-containing silicate glass, or comprises this material.

Alternatively, the invention comprises a method for manufacturing the break-resistant glass assembly of a single-rod measuring chain comprising a break-resistant ion-sensitive membrane, comprising: providing a glass body of a single-rod measuring chain containing an inner shaft tube having a cylindrical cavity and an outer shaft tube surrounding the inner shaft tube and integrally bonded to the inner shaft tube and closed at the bottom; blowing or melting a lithium-containing membrane glass onto the cylindrical cavity of the inner shaft tube, wherein the membrane glass consists of a sodium-and lithium-containing glass, preferably of sodium and lithium silicate glass, or of a lithium-containing glass, preferably of lithium silicate glass, or comprises one of these materials; bringing the at least one membrane glass blown onto a shaft into contact with a pickling solution or a melt containing sodium ions, preferably a sodium acetate or sodium nitrate solution or a melt containing sodium ions; heating the membrane glass at a temperature of 200° C.-500° C., preferably 300-450° C., more preferably 400-450° C. for 10-20 minutes, wherein the membrane glass is ion-sensitive.

The inner shaft tube and the outer shaft tube are arranged coaxially. The integral bond between the inner shaft tube and the outer shaft tube is provided by fusion. The integral bond and the ion-sensitive membrane glass are arranged on the side of the glass body of the single-rod measuring chain facing the medium during operation.

In a preferred embodiment of the above-mentioned method, the glass body of the single-rod measuring chain consists of a sodium-containing glass hardened with K+ions, preferably sodium silicate glass, or comprises this material.

In one embodiment of the above-mentioned methods for manufacturing the break-resistant glass assembly comprising an ion-sensitive membrane, the method further comprises a method according to the invention for manufacturing a break-resistant ion-sensitive membrane glass or an embodiment thereof.

The invention also relates to a glass assembly of a single-rod measuring chain comprising an inner shaft tube having a cylindrical cavity and an outer shaft tube surrounding the inner shaft tube and integrally bonded to the inner shaft tube and closed at the bottom, and
a break-resistant ion-sensitive membrane glass blown onto the shaft tube, wherein the break-resistant ion-sensitive membrane glass comprises or consists of lithium ion silicate glass, wherein at least a portion of the lithium ions are replaced with sodium ions.

In one embodiment of the glass assembly, the break-resistant ion-sensitive membrane glass is obtainable by the method according to the method according to the invention for manufacturing a break-resistant membrane glass or an embodiment thereof.

The integral bond and the ion-sensitive membrane glass are arranged on the side of the glass assembly of the single-rod measuring chain facing the medium during operation.

The invention also relates to a break-resistant electrochemical sensor comprising: a glass assembly according to the invention or an embodiment thereof; a measuring half-cell and a reference half-cell, in each case comprising a lead and an electrolyte; and an electronics unit, which is electrically connected to the lead of the measuring half-cell and the lead of the reference half-cell.

All the modular systems and the measuring systems described above can be combined with each other in each case, provided that this is technically possible.

### BRIEF DESCRIPTION OF THE DRAWINGS

The invention is explained in more detail in the following description with reference to the embodiments shown in the drawing.

In which:

FIG. 1 shows an embodiment of a glass component of a measuring half-cell obtainable by the method according to the invention.

FIG. 2: shows an embodiment of a glass assembly obtainable by the method according to the invention.

### DETAILED DESCRIPTION

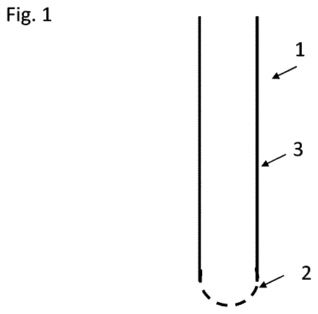

FIG. 1 shows a glass component (1) of a measuring half-cell comprising a break-resistant ion-sensitive membrane glass (2) and a shaft (3) of the glass component.

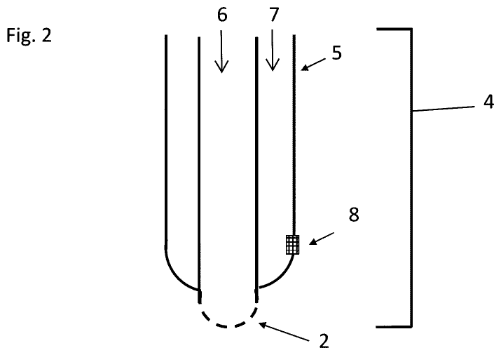

FIG. 2 shows a glass assembly (4) comprising a break-resistant ion-sensitive membrane glass (2), a glass body (5) comprising an inner shaft tube (6) and an outer shaft tube (7), which consist of break-resistant glass or of a non-break-resistant glass. The break-resistant glass of the shaft tubes comprises a glass containing sodium ions, preferably a sodium silicate glass, in which at least some of the sodium ions have been exchanged for potassium ions, or the break-resistant glass consists of this material. The outer shaft tube (7) has a diaphragm (8). The inner shaft tube (6) is integrally bonded, preferably by fusing, to the break-resistant, ion-sensitive, lithium-containing membrane glass (2), in which at least some of the lithium ions have been replaced by sodium ions. The hardened ion-sensitive glass is obtained by a method according to the invention or an embodiment thereof.

1. A method for manufacturing a break-resistant membrane glass of a glass component of a measuring half-cell of an analyte-sensitive sensor, comprising:
providing at least one membrane glass of a sensor which is blown onto a shaft and which consists of a sodium-and lithium-containing glass;
bringing the at least one membrane glass blown onto a shaft into contact with a pickling solution containing sodium ions; and
heating the membrane glass at a temperature of 200° C.-500° C. for 10-20 minutes, wherein the membrane glass is ion-sensitive.

2. The method of claim 1, wherein the pickling solution containing sodium ions further contains potassium ions.

3. The method of claim 1, wherein the bringing into contact with a pickling solution step comprises immersing in the pickling solution or spraying with the pickling solution.

4. The method of claim 3, wherein after immersion in the pickling solution or spraying with the pickling solution, the glass is heated with a laser.

5. The method of claim 1, wherein at least the membrane glass is immersed in the melt.

6. The method of claim 5, wherein the membrane glass is subsequently brought into contact with a pickling solution.

7. The method of claim 1, wherein the ion-sensitive sensor is a cation-sensitive sensor.

8. The method of claim 7, wherein the cation-sensitive sensor is a Na⁺, K⁺ sensor or a pH-sensitive or hydronium-ion-sensitive sensor.

9. The method of claim 1, wherein the shaft consists of a sodium silicate glass hardened with potassium ions or contains a sodium silicate glass hardened with potassium ions.

10. The method of claim 1, followed by the steps:
cooling the glass component containing a shaft and break-resistant membrane glass blown onto the shaft and integrally bonded to the glass component to room temperature; and
cleaning the glass component.

11. A method for manufacturing a break-resistant glass assembly of an ion-sensitive single-rod measuring chain comprising hardened ion-sensitive membrane glass, comprising:
providing a glass body containing an inner shaft tube having a cylindrical cavity and an outer shaft tube surrounding the inner shaft tube and integrally bonded to the inner shaft tube and closed at the bottom;
inserting a cylindrical diaphragm into a receptacle of the inner shaft tube, the diaphragm containing an O-ring on the outer surface for sealing with the inner shaft tube;
manufacturing a break-resistant membrane glass of a glass component of a measuring half-cell manufacturing a break-resistant membrane glass of a glass component of a measuring half-cell of an analyte-sensitive sensor, by:
providing at least one membrane glass of a sensor which is blown onto a shaft and which consists of a sodium-and lithium-containing glass;
bringing the at least one membrane glass blown onto a shaft into contact with a pickling solution containing sodium ions; and
heating the membrane glass at a temperature of 200° C.-500° C. for 10-20 minutes, wherein the membrane glass is ion-sensitive; and
inserting the glass component of a measuring half-cell, containing a shaft tube and a pH-sensitive glass membrane integrally bonded to the shaft tube, into the cylindrical cavity.

12. A glass assembly of a single-rod measuring chain for an analyte-sensitive sensor, comprising:
an inner shaft tube having a cylindrical cavity;
an outer shaft tube surrounding the inner shaft tube and integrally bonded to the inner shaft tube and closed at the bottom; and
a break-resistant ion-sensitive membrane glass blown onto the shaft tube, wherein the break-resistant ion-sensitive membrane glass comprises or consists of lithium ion silicate glass, wherein at least a portion of the lithium ions are replaced with sodium ions.

13. The glass assembly of claim 12, wherein the break-resistant ion-sensitive membrane glass is obtained by:
providing at least one membrane glass of a sensor which is blown onto a shaft and which consists of a sodium-and lithium-containing glass;
bringing the at least one membrane glass blown onto a shaft into contact with a pickling solution containing sodium ions; and
heating the membrane glass at a temperature of 200° C.-500° C. for 10-20 minutes, wherein the membrane glass is ion-sensitive.

14. A break-resistant electrochemical sensor comprising:
a glass assembly including:
an inner shaft tube having a cylindrical cavity;
an outer shaft tube surrounding the inner shaft tube and integrally bonded to the inner shaft tube and closed at the bottom; and
a break-resistant ion-sensitive membrane glass blown onto the shaft tube, wherein the break-resistant ion-sensitive membrane glass comprises or consists of lithium ion silicate glass, wherein at least a portion of the lithium ions are replaced with sodium ions;
a measuring half-cell and a reference half-cell, in each case comprising a lead and an electrolyte; and
an electronics unit, which is electrically connected to the lead of the measuring half-cell and the lead of the reference half-cell.
